(19) United States
(12) Patent Application Publication
(10) Pub. No.: US 2006/0050133 A1
(43) Pub. Date: Mar. 9, 2006

(54) Luminous device and optical fixing device

(75) Inventor: Hideyuki Kokubo, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/214,755

(22) Filed: Aug. 31, 2005

(30) Foreign Application Priority Data
Sep. 8, 2004 (JP) 2004-261554

(51) Int. Cl. B41J 2/385; G03G 13/04

(52) U.S. Cl. 347/129

(57) ABSTRACT

A luminous device comprises an array of LEDs aligned in a plural number “m” of lines which extend in a main scan direction, and are apposed in a sub scan direction orthogonal to the main scan direction. The array is grouped into a number of blocks to be driven block by block, each block consisting of a number “q” of LEDs connected in serial to one another, wherein q=m. Where the numbers “q” and “m” are five and two respectively, two or three of the five LEDs of the same block are located in one of the two lines (L1), whereas other LEDs of that block are located in the other line (L2), such that the LEDs of the different blocks are located substantially in the same column in the sub scan direction, to distribute the LEDs of the same block in the main scan direction. Thereby, unevenness in integral illuminance in the sub scan direction is reduced even if there are illuminance variations between the blocks.

### FIELD OF THE INVENTION

The present invention relates to a luminous device that has a plural blocks of light emitting elements which are connected in serial to each other in each block, so as to activate the light emitting elements block by block. The present invention also relates to an optical fixing device for a direct color thermal printer, using the luminous device.

### BACKGROUND ARTS

The direct color thermal printer uses heat sensitive color recording paper that has at least three heat sensitive coloring layers that develop different colors and are formed atop another. The coloring layers have the lower heat sensitivity as they are formed in the lower position from an obverse surface. The first and second coloring layers from the obverse surface are designed to be fixed by ultraviolet rays of respective specific wavelength ranges. While the heat sensitive color recording paper is being conveyed back and forth, a thermal head is pressed on the recording paper to heat it for recording pixels of one color on one coloring layer after another in the order from the obverse side. After the thermal recording, the first and second coloring layers are respectively fixed by the ultraviolet rays, so that these coloring layers may not develop color during the thermal recording of the lower coloring layers. The ultraviolet rays are projected from an optical fixing device that conventionally uses at least an ultraviolet straight lamp as a light source.

Recently, many inventions have suggested using light emitting elements like light emitting diodes as a light source for the optical fixing device. According to these prior arts, the light emitting elements are arranged along a main scan direction that is orthogonal to a transport direction of the heat sensitive color recording paper. The light emitting elements are superior to a halogen lamp in directivity of light beams as well as in energy efficiency, so it is advantageous using them as a light source device in terms of making the apparatus compact and saving energy consumption.

However, the light emitting elements are likely to have variations in light emitting characteristics between individual products or between their production lots. As a result of such variations, light intensity of one light emitting element can differ from that of another light emitting element even while they are activated under the same electric conditions. If there are variations in light intensity between the light emitting elements that constitute a light source for fixing the first coloring layer of the heat sensitive recording paper, e.g. a yellow coloring layer, the yellow coloring layer will be partially unfixed, so the unfixed portion will be unexpectedly colored yellow during the thermal recording on the second coloring layer, e.g. a magenta coloring layer. This will cause density unevenness, and thus lower the quality of printed images.

To reduce the unevenness in light intensity and thus in fixing condition, Japanese Laid-open Patent Application No. 2003-285456 suggests using a light emitting element array that is constituted of ultraviolet light emitting elements arranged in a matrix along the main and sub scan directions. An integral illuminance of a number of light emitting elements of each column, which are aligned in the sub scan direction, is calculated to detect distribution of illuminance in the main scan direction. Then, the integral illuminances of the individual columns are adjusted so as to make the illuminance distribution even in the main scan direction. Thereby, the unevenness in light intensity of the optical fixing device in the main scan direction is reduced to the minimum.

For example, as shown in FIG. 20A, six light emitting diodes (LED) 101 are connected in serial to each other and aligned in the sub scan direction to constitute an LED column or block 102. A number of such blocks, e.g. 36 blocks, are apposed across the main scan direction, to constitute a light emitting element array 100 arranged in a matrix of 36 columns×6 lines. In the example shown in FIG. 20A, the LEDs 101 of one LED block 102 are staggered by a half pitch from those of adjacent LED blocks 102 in the sub scan direction. This arrangement makes illuminance distribution more even and uniform. The LED blocks 102 are each individually connected in serial to a current control circuit 103, through which the LED blocks 102 are supplied from a power source 104 for the LEDs 101 that is constituted of a current stabilizing power source.

The current control circuit 103 consists of a transistor 105 and a variable resistor 103, wherein drive pulses are supplied from a CPU 107 through the resistor 106 to a base of the transistor 105. The transistor 105 functions as a switch that turns the respective LEDs 101 of the associated LED block 102 on or off by controlling current flowing through the associated LED block 102. The variable resistor 106 can vary its resistance, so it can control the current supplied to the LEDs 101. Accordingly, while the drive pulses supplied from the CPU 107 are in a high level, the transistor 105 and thus the LEDs 101 of the corresponding LED block 102 are turned ON. They are turned OFF while the drive pulses are in a low level. The CPU 107 controls duty ratio of the drive pulses based on an illuminance signal, to correct the illuminance of the light emitting element array 100 during the fixing. The duty ratio of the drive pulses is a ratio of a pulse width W to a pulse interval T, as shown in FIG. 20B.

The same drive pulses are fed from the CPU 107 to the respective transistors 105. Connecting the transistor 105 to each LED block 102 makes it possible to activate selected ones of the LED blocks 102, for example, in accordance with the width of the heat sensitive color recording paper. The light emitting element array 100 is configured in the same way as for yellow fixing and for magenta fixing.

However, according to this prior art, it is necessary for correcting variations or unevenness of illuminance of the optical fixing device in the main scan direction, to connect the current control circuit 103 to each of the LED blocks 102, and control the drive current of each LED block 102 individually. Therefore, it has been expected to simplify the circuitry and save the cost more effectively.

### SUMMARY OF THE INVENTION

In view of the foregoing, a primary object of the present invention is to provide a luminous device having an array of light emitting elements, that suppresses illuminance unevenness at a low cost without the need for any complicated structure.

Another object of the present invention is to provide an optical fixing device for a direct color thermal printer, using the luminous device of the present invention.

To achieve the above and other objects, a luminous device of the present invention comprises an array of light emitting elements aligned in a plural number “m” of lines which extend in a first direction, and are apposed in a second direction orthogonal to the first direction, and the array is grouped into a number of blocks to be driven block by block, each of the blocks consisting of a number “q” of light emitting elements connected in serial to one another, the number “q” being equal to or larger than the number “m”, and wherein the light emitting elements of each block are divided into the number “m” of subgroups consisting of one or more than one of the light emitting elements each, such that one subgroup is allocated to one line in each block, to arrange the light emitting elements of different blocks substantially in the same columns in the second direction.

The light emitting elements of one line are preferably staggered by P/2 from ones of adjacent lines in the first direction, assuming that the light emitting elements are arranged at an interval of P in each line.

It is also preferable to stagger the light emitting elements of one line by P/m from ones of adjacent lines, assuming that the light emitting elements are arranged at an interval of P in each line.

According to the luminous device of the present invention, because the serially connected light emitting elements of each block are distributed in the first and second directions, illuminance unevenness is made inconspicuous even if there are variations in light volume between the blocks, which are resulted from characteristic differences between the individual light emitting elements. Especially where the luminous device of the present invention is applied to the optical fixing device for the direct color thermal printer, variations in amount of integral light in the second direction or the sub scan direction between the blocks are made inconspicuous as they are averaged in the first direction or the main scan direction. Namely, intervals of the illuminance unevenness between the blocks are elongated in the first direction, and overlapped with other blocks, illuminance unevenness or variations in amount of integral light become inconspicuous. Therefore, it is unnecessary to provide a current regulator to each block to keep the current constant, which contributes to reducing the scale of the apparatus and saving the cost.

The luminous device of the present invention is applicable not only to the optical fixing device for the direct color thermal printer, but also to a light source for an image reading apparatus or a flat display panel.

By making the number “q” of light emitting elements of each block equal to the line number “m”, the degree of distribution of the light emitting elements in the main scan direction is raised within the same block. So the illuminance unevenness between the blocks becomes inconspicuous. By setting q>m, the line number “m” may be reduced, which contributes to making the luminous device smaller.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a schematic diagram illustrating a direct color thermal printer;

FIG. 2 is a schematic top plan view illustrating an arrangement of LEDs constituting light emitting element arrays for yellow and magenta of an optical fixing device, according to a first embodiment of the present invention;

FIG. 3 is a block diagram illustrating the circuitry of the light emitting element array for yellow;

FIG. 4 is a block diagram illustrating the circuitry of the light emitting element array for magenta;

FIG. 5 is a block diagram illustrating an LED driver IC;

FIG. 6 is a schematic top plan view illustrating an example of wiring pattern of the respective light emitting element arrays;

FIG. 7 is a graph showing a relationship between the pitch of density unevenness and visually permissible level of density unevenness;

FIG. 8 is a graph showing a relationship between integral illuminance in the sub scan direction of each block of the yellow fixing light emitting element array, and an effect of suppressing illuminance unevenness across the main scan direction;

FIG. 9 is a graph showing a relationship between integral illuminance in the sub scan direction of each block of the magenta fixing light emitting element array, and an effect of suppressing illuminance unevenness across the main scan direction;

FIG. 10 is a schematic top plan view illustrating a light emitting element array according to a second embodiment of the present invention;

FIG. 11 is a block diagram illustrating the circuitry of the light emitting element array of FIG. 10;

FIG. 12 is a schematic top plan view illustrating a light emitting element array according to a third embodiment of the present invention, wherein the light emitting elements of one line are staggered from those of the adjacent lines;

FIG. 13 is a block diagram illustrating the circuitry of the light emitting element array of FIG. 12;

FIG. 14 is a schematic top plan view illustrating a light emitting element array according to a fourth embodiment of the present invention, wherein the light emitting elements of one line are staggered from those of the adjacent lines;

FIG. 15 is a schematic perspective illustrating an illuminance measuring device for measuring illuminance distribution of an individual light emitting element array;

FIG. 16 is a flowchart illustrating a sequence of manufacturing a direct color thermal printer;

FIG. 17 is a schematic perspective illustrating an illuminance measuring device for measuring illuminance distribution of an individual light emitting element array;

FIG. 18 is a schematic diagram illustrating an image reading apparatus for reading images from photographic film, which uses a luminous device of the present invention;

FIG. 19 is a schematic diagram illustrating a flat panel display using a luminous device of the present invention;

FIG. 20A is a block diagram illustrating a conventional light emitting element array;

FIG. 20B is a signal diagram illustrating drive pulses for the conventional light emitting element array; and

FIG. 21 is a graph showing a relationship between integral illuminance in the sub scan direction of each block of the light emitting element array of FIG. 20A, and an effect of suppressing illuminance unevenness across the main scan direction.

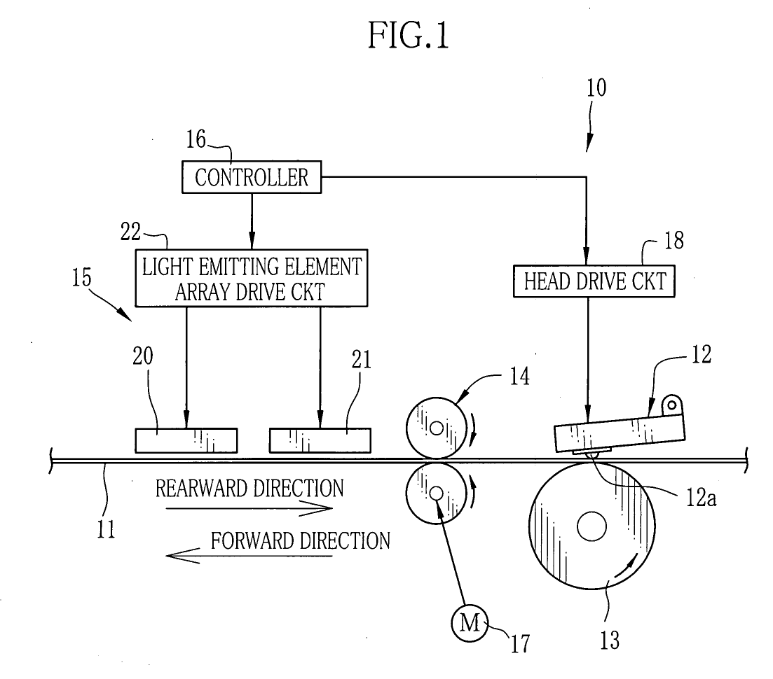

### DESCRIPTION OF THE PREFERRED EMBODIMENTS

A direct heat sensitive type color thermal printer 10 carries out thermal recording and optical fixing to print a full-color image on heat sensitive color recording paper 11, hereinafter called simply the recording paper, while conveying the recording paper 11 forward and rearward. The thermal printer 10 is constituted of a thermal head 12 for heating the recording paper 11 to let its heat sensitive coloring layers develop respective colors sequentially from the obverse, a platen roller 13 placed in opposition to the thermal head 12 to support the recording paper 11, a pair of conveyer rollers 14 for conveying the recording paper 11, an optical fixing device 15 and a controller 16 for controlling the respective components of the color thermal printer 10.

The recording paper 11 has heat sensitive coloring layers for cyan, magenta and yellow, which are formed atop another on a base material in this order from the bottom. Among these heat sensitive coloring layers, the topmost yellow coloring layer has the highest heat sensitivity, so it develops yellow with the smallest amount of heat energy, whereas the bottommost cyan coloring layer has the lowest heat sensitivity, so it develops yellow with the smallest amount of heat energy, whereas the bottommost cyan coloring layer has the lowest heat sensitivity, so it develops cyan with the largest amount of heat energy. The yellow coloring layer loses its coloring ability when it is exposed to ultraviolet rays of 420 nm. The second from the obverse coloring layer for magenta develops its color with heat energy of an intermediate amount between those for the yellow coloring layer and the cyan coloring layer, and loses its coloring ability when it is exposed to near-ultraviolet rays of 365 nm. The recording paper 11 may have four coloring layers by adding a fourth heat sensitive coloring layer, e.g. a black coloring layer.

The conveyer rollers 14 nip the recording paper 11 and convey it in a sub scan direction through the thermal head 12 and the optical fixing device 15. After having a full-color image recorded thereon, the recording paper 11 is cut into a given length, and is ejected out of the color thermal printer 10. The conveyer rollers 14 are driven by a drive motor 17.

The thermal head 12 is provided with a heating element array 12a that consists of a large number of heating elements aligned in a main scan direction orthogonal to the sub scan direction, as well-known in the art. The heating elements radiate heat energies of variable amounts depending upon densities of pixels to record on the respective coloring layers. The thermal head 12 is driven by a head drive circuit 18.

The optical fixing device 15 is constituted of two light emitting element arrays 20 and 21 and a light emitting element array drive circuit 22 for driving either of these light emitting element arrays 20 and 21. The light emitting element arrays 20 and 21 are placed in a downstream position of the thermal head 12 with respect to the forward conveying direction of the recording paper 11, with their light emitting surfaces opposed to the obverse recording surface of the recording paper 11. The light emitting element array 20 is a fixing light source for the yellow coloring layer, which projects violet rays with a light emission peak at 420 nm. The light emitting element array 21 is a fixing light source for the magenta coloring layer, which projects near-ultraviolet rays with a light emission peak at 365 nm.

To record a full-color image, the recording paper 11 is conveyed first in the forward direction. Synchronously with the conveying movement, the heating element array 12a of the thermal head 12 is driven in accordance with image data, to record an yellow frame of the full-color image thermally on the yellow coloring layer in a designated image recording area of the recording paper 11. After the yellow recording, the yellow fixing light emitting element array 20 is turned on to project the fixing light of 420 nm onto the image recording area, thereby to fix the yellow coloring layer in the image recording area. Thereafter, the recording paper 11 is conveyed in the rearward direction to set it back to a start recording position. Next, the recording paper 11 is conveyed again in the forward direction, while a magenta frame of the full-color image is thermally recorded on the magenta coloring layer in the same image recording area. Then the magenta fixing light emitting element array 21 is turned on to fix the magenta coloring layer in the image recording area by the fixing light of 365 nm. Thereafter, the recording paper 11 is returned to the start recording position, and a cyan frame of the same full-color image is thermally recorded on the cyan coloring layer in the same image recording area, as the recording paper 11 is conveyed in the forward direction. As a result, the full-color image is produced in a frame sequential fashion. While the recording paper 11 is further conveyed in the forward direction, the magenta fixing light emitting element array 21 is turned on to bleach uncolored portions of the image recording area. The image recording area having the full-color image printed thereon is cut off the recording paper 11.

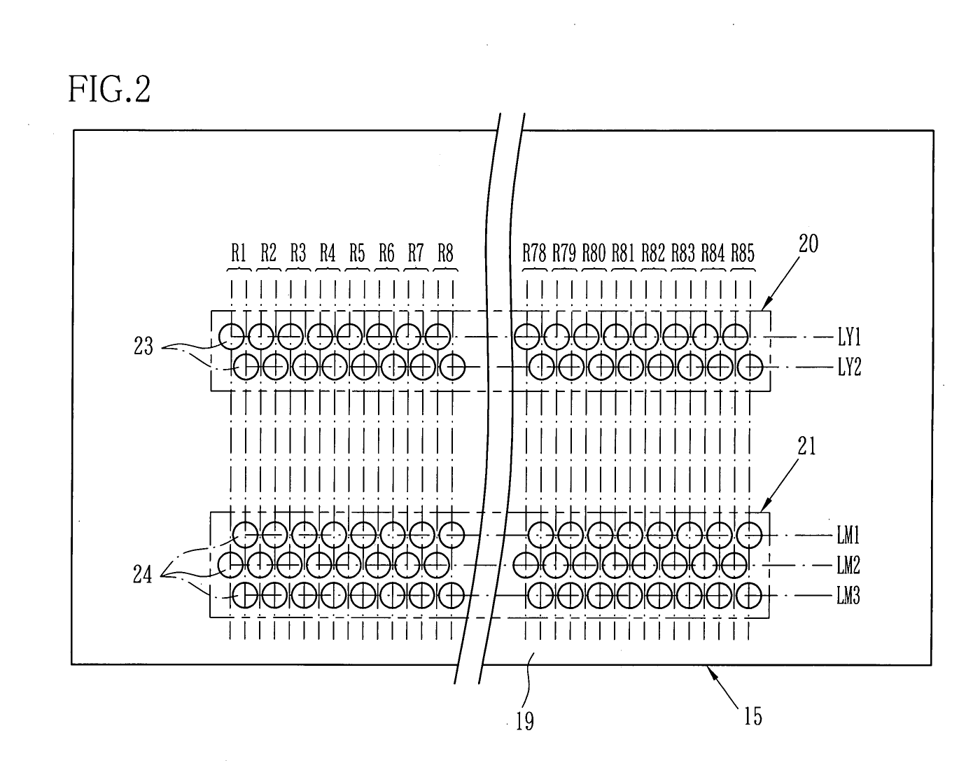

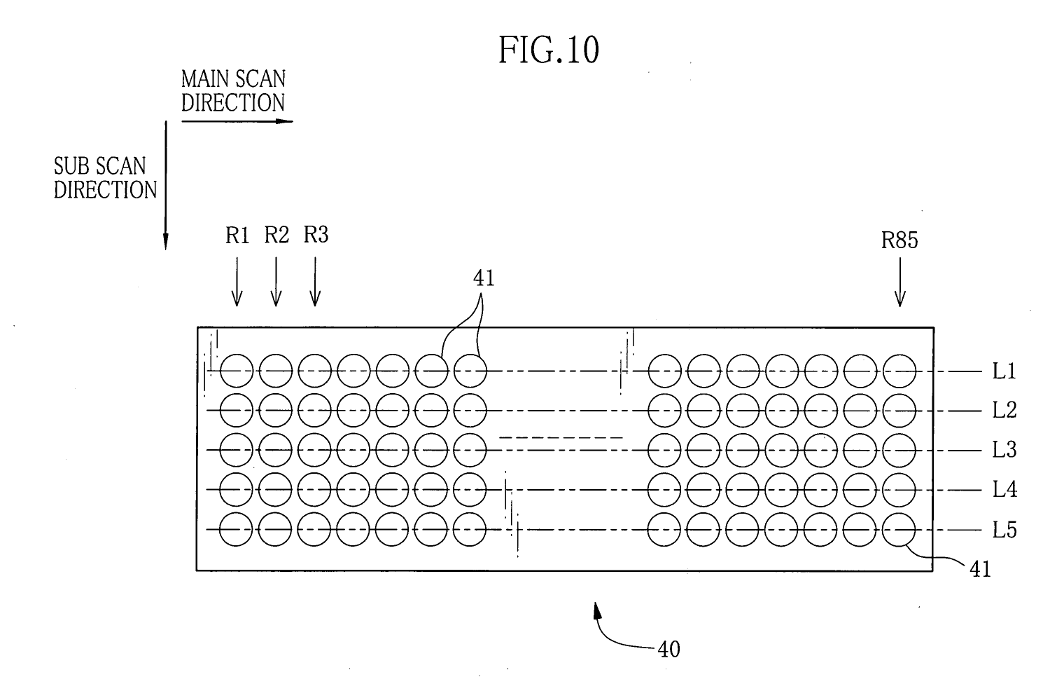

As shown in FIG. 2, the yellow fixing light emitting element array 20 consists of a large number of LEDs (light emitting diodes) 23 that emit violet rays having a light emission peak at 420 nm and are arranged on a substrate 19 along the main scan direction (first direction) and the sub scan direction (second direction). In the present embodiment, the LEDs 23 are arranged in two lines LY1 and LY2 along the main scan direction (m=2), each line consisting of eighty-five light emitting elements, i.e. LEDs 23 (n=85). The LEDs 23 of the first line LY1 are shifted in the main scan direction from the LEDs 23 of the second line LY2 by an amount corresponding to a half pitch or interval between the LEDs 23 of the same line. Staggering the LEDs 23 in this way will reduce unevenness of illuminance in the sub scan direction more than a case where the light emitting elements are not staggered in the main scan direction, like as shown in FIG. 10.

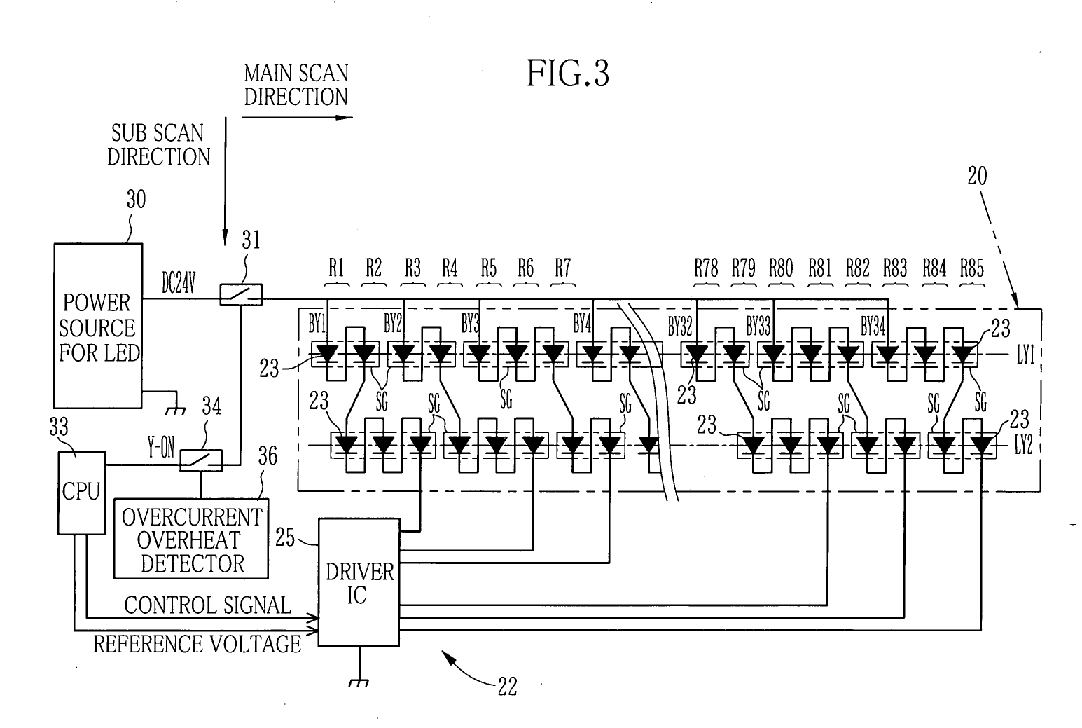

As shown in FIG. 3, every five of the LEDs 23 are connected in serial to each other to form a block (q=5), and a driver IC 25 drives the LEDs 23 by each block individually. The first block BY1 consists of two LEDs 23 placed in the first and second columns R1 and R2 of the first line LY1, and three LEDs 23 placed in the first to third columns R1, R2 and R3 of the second line LY2. The second block BY2 consists of two LEDs 23 placed in the third and fourth columns R3 and R4 of the first line LY1, and three LEDs 23 placed in the fourth to sixth columns R4, R5 and R6 of the second line LY2. The third block BY3 consists of three LEDs 23 placed in the fifth to seventh columns R5, R6 and R7 of the first line LY1, and two LEDs 23 placed in the seventh and eighth columns R7 and R8 of the second line LY2.

From the fourth block BY4 to the thirty-third block BY33, the LEDs 23 are arranged in the same patterns as the second and third blocks BY2 and BY3, wherein two LEDs 23 of one block are aligned with three LEDs 23 of the adjacent block alternately in each line LY1 or LY2. The thirty-fourth block BY34 consists of three LEDs of the first line LY1 and two LEDs of the second line LY2. In this way, the five LEDs 23 of each block are divided into a subgroup SG of two LEDs 23 and a subgroup SG of three LEDs 23, and the subgroups SG of each block are placed separately in the first and second lines LY1 and LY2. According to this arrangement, if uneven characteristics of the LEDs 23 provide illuminance variations between the blocks BY1 to BY34, the unevenness of illuminance will be less conspicuous.

Referring back to FIG. 2, the magenta fixing light emitting element array 21 consists of a large number of LEDs 24 that emit near-ultraviolet rays having a light emission peak at 365 nm and are arranged on the substrate 19 along the main scan direction and the sub scan direction. In the present embodiment, the LEDs 24 are arranged in three lines LM1, LM2 and LM3 along the main scan direction (m=3), each line consisting of 85 elements 24 (n=85). The LEDs 24 of each line LM1 to LM3 are shifted in the main scan direction from the LEDs 24 of the adjacent lines by an amount corresponding to a half pitch or interval between the LEDs 24 of the same line.

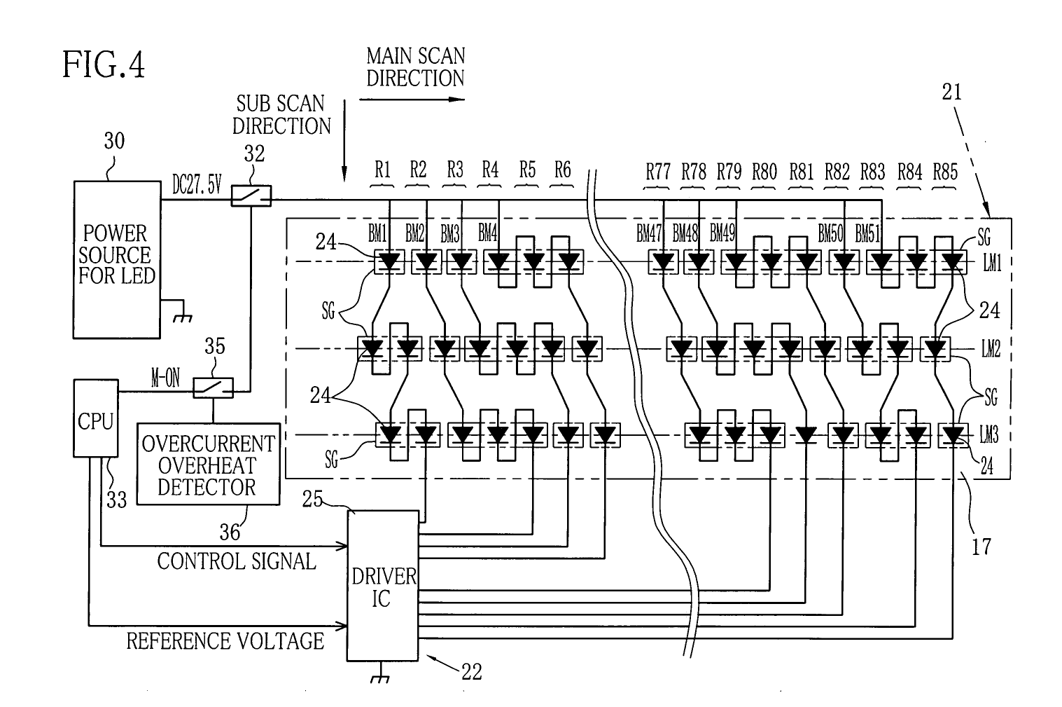

As shown in FIG. 4, every five of the LEDs 24 are connected in serial to each other to form a block (q=5), and the driver IC 25 drives the LEDs 24 by each block individually. The first block BM1 consists of one LED 24 placed in the first column R1 of the first line LM1, two LEDs 24 placed in the first and second columns R1 and R2 of the second line LM2, and two LEDs 24 placed in the first and second columns R1 and R2 of the third line LM3.

The second block BM2 consists of one LED 24 placed in the second column R2 of the first line LM1, one LED 24 placed in the third column R3 of the second line LM2, and three LEDs 24 placed in the third to fifth columns R3, R4 and R5 of the third line LM3. The third block BM3 consists of one LED 24 placed in the third column R3 of the first line LM1, three LEDs 24 placed in the fourth to sixth columns R4 and R6 of the second line LM2, and one LED 24 placed in the sixth column R6 of the third line LM3. The fourth block BM4 consists of three LEDs 24 placed in the fourth to sixth columns R4 to R6 of the first line LM1, one LED 24 placed in the seventh column R7 of the second line LM2, and one LED 24 placed in the seventh column R7 of the third line LM3.

From the fifth block BM5 to the forty-ninth block BM49, the LEDs 24 are arranged in the same pattern as the second to fourth blocks BM2 to BM4. That is, the five LEDs 24 of the respective blocks BM5 to BM49 are divided into three subgroups SG, two of which consist of one LED 24 and one of which consists of three LEDs 24, and the three subgroups SG of each block are distributed into the first to third lines LM1 to LM3, such that the LEDs 24 constituting the subgroups SG of the different blocks BM5 to BM49 are arranged on each line in the sequence of one LED 24, one LED 24 and three LEDs 24. In addition, the LEDs 24 of the same block are staggered with respect to the sub scan direction. The fiftieth block BM50 consists of one LED located in the eighty-second column R82 of the first line LM1, two LEDs 24 located in the eighty-third and eighty-fourth columns R83 and R84 of the second line LM2, and two LEDs 24 located in the eighty-third and eighty-fourth columns R83 and R84 of the third line LM3. The fifty-first block BM51 consists of three LEDs 24 located in the eighty-third to eighty-fifth column of the first line LM1, one LED 24 located in the eighty-fifth column of the second line LM2 and one LED 24 located in the eighty-fifth column of the third line LM3. Consequently, each of the second to forty-ninth blocks consists of two subgroups SG consisting of one LED 24 and one subgroup SG consisting of three LEDs 24, and these three subgroups SG are distributed alternately into the three lines LM1 to LM3. Therefore, if uneven characteristics of the LEDs 24 provide illuminance variations between the blocks BM1 to BM50, the unevenness of illuminance will be less conspicuous.

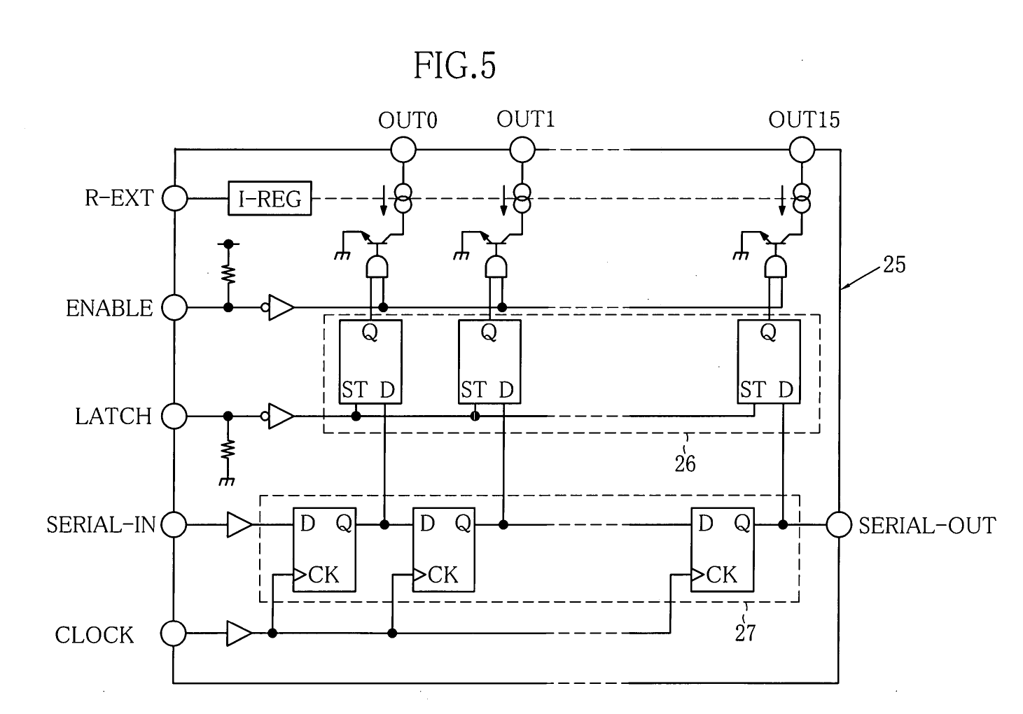

Next, the light emitting element drive circuit 22 will be described with reference to FIGS. 3 to 5. As shown in FIGS. 3 and 4, the power source 30 for the LEDs, which is a current stabilizing power source, applies a voltage of 24V across the LEDs 23 of the first to thirty-fourth blocks BY1 to BY34 of the yellow fixing light emitting element array 20 through a field effect transistor switch (FET-SW) 31. Furthermore, the power source 30 applies a voltage of 27.5V across the LEDs 24 of the first to fifty-first blocks BM1 to BM51 of the magenta fixing light emitting element array 21 through a field effect transistor switch (FET-SW) 32. The FET-SW 31 for yellow is turned ON or OFF responsive to an LED control signal for yellow that is sent from the CPU 33 of the controller 16. While the FET-SW 31 is ON, the voltage of 24V is applied across the LEDs 23 of the respective blocks BY1 to BY34. The FET-SW 32 for magenta is also turned ON or OFF responsive to an LED control signal for magenta that is sent from the CPU 33 of the controller 16. While the FET-SW 32 is ON, the voltage of 27.5V is applied across the LEDs 24 of the respective blocks BM1 to BM34.

Control switches 34 and 35 are connected in serial between the respective FET-SW 31 and 32 and the CPU 33, and an overcurrent overheat detector 36 is connected to the respective FET-SW 31 and 32, such that the overcurrent overheat detector 36 turns the FET-SW 31 or 32 OFF when a current surge or overheat is detected in the light emitting element array 20 or 21. Then, the corresponding FET-SW 31 or 32 is turned OFF to stop applying the voltage across the LEDs 23 or 24.

As shown in FIGS. 3 to 5, the driver IC 25 drives the light emitting element arrays 20 and 21 to emit light alternately. The driver IC 25 is preferably a constant current LED driver produced by Toshiba Semiconductor under the type number of TB62726AN or TB6262726AF. The driver IC has an R-EXT terminal, an ENABLE terminal, an LATCH terminal, a SERIAL-IN terminal, a CLOCK terminal, a SERIAL-OUT terminal and output terminals for outputting signal to the respective LEDs 23 and 24. In the present embodiment, the driver IC 25 has sixteen output terminals OUT1 to OUT15, and a requisite number of such driver ICs 25 are provided in correspondence with the number of blocks BY1 to BY34 and BM1 to BM51 of the light emitting element arrays 20 and 21.

The driver IC 25 is individually connected to the CPU 33 through the R-EXT terminal and a current regulator I-REG, so that a regular current whose value is selected in a range from 2 to 80 mA is supplied to the LEDs of the respective blocks through the output terminals OUT0 to OUT15. The driver IC 25 produces ON-OFF data to the output terminals OUT0 to OUT15 in accordance with a combination of signals applied to the ENABLE terminal, the LATCH terminal, the SERIAL-IN terminal and the CLOCK terminal, in a manner as shown in the following truth table:

| CLOCK | LATCH | ENABLE | SERIAL-IN | OUT0 . . . OUT7 . . . OUT15 | SERIAL-OUT |
|---|---|---|---|---|---|
| UP | H | L | Dn | Dn . . . Dn − 7 . . . Dn − 15 | Dn − 15 |
| UP | L | L | Dn + 1 | NO CHANGE | Dn − 14 |
| UP | H | L | Dn + 2 | Dn + 2 . . . Dn − 5 . . . Dn − 13 | Dn − 13 |
| DOWN | X | L | Dn + 3 | Dn + 2 . . . Dn − 5 . . . Dn − 13 | Dn − 13 |
| DOWN | X | H | Dn + 3 | OFF | Dn − 13 |

When the ON-OFF data is a high(H) level at any of the output terminals OUT0 to OUT15, the LEDs of the associated block are turned ON. On the contrary, when the ON-OFF data is a low(L) level at any of the output terminals OUT0 to OUT15, the LEDs of the associated block are turned OFF. The LATCH terminal is connected to a level-latch circuit 26 that holds data from a shift register 27 so long as the signal on the LATCH terminal is in a low(L) level. While the signal on the LATCH terminal is in a high(H) level, the data is passed through the latch circuit 26. By setting the signal at the ENABLE terminal to a low(L) level, the output terminals OUT0 to OUT15 are turned ON or OFF in accordance with the ON-OFF data applied thereto. By setting the signal at the ENABLE terminal to a high(H) level, all of the output terminals OUT0 to OUT15 are turned OFF, regardless of the ON-OFF data.

According to the embodiment shown in FIGS. 3 and 4, the number “q” of those LEDs connected in serial to each other to constitute one block is five, and the number “m” of lines in the sub scan direction is two in the yellow fixing light emitting element array 20, and three in the magenta fixing light emitting element array 21. So it satisfies the condition: m<q. By staggering the LEDs 23 and 24 in the main scan direction in almost all blocks except the terminal blocks BY1, BY34, BM1, BM50 and BM51, illuminance unevenness across the main scan direction is made unconscious in the center portion of the image recording area, where the illuminance unevenness would have more influence on the image quality.

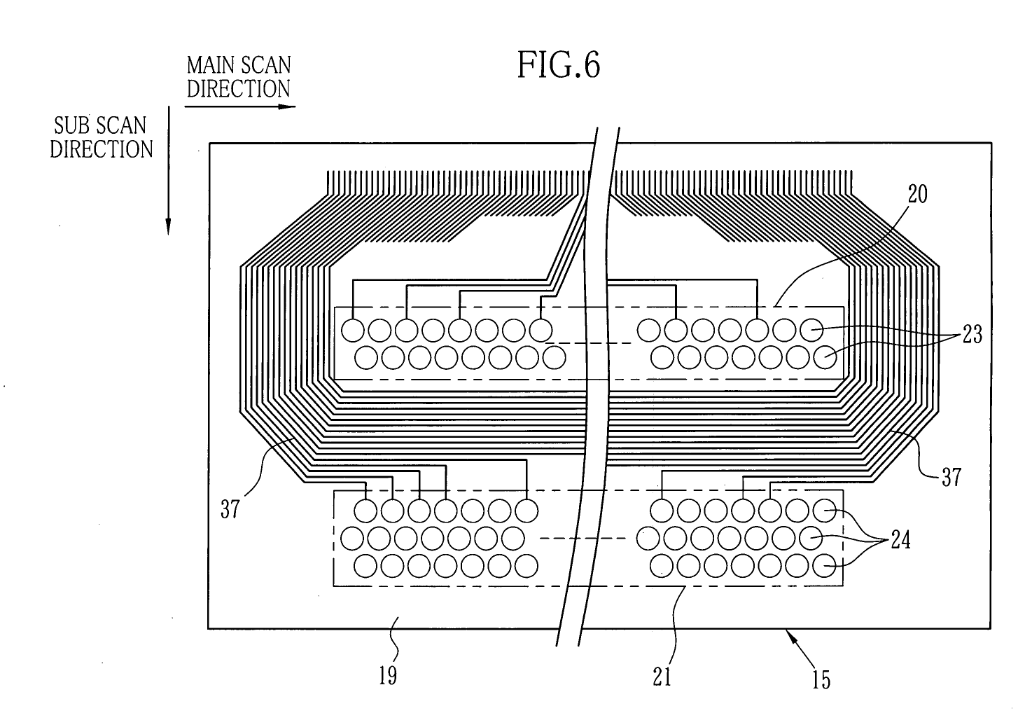

FIG. 6 shows an example of wiring patterns 37 of the yellow fixing light emitting element array 20 and the magenta fixing light emitting element array 21 of the optical fixing device 15. The wiring patterns 37, which conduct current to the LEDs 23 and 24 of the respective blocks of the yellow fixing light emitting element array 20 and the magenta fixing light emitting element array 21, are formed on an LED mounting surface of a substrate 19, so as to detour the LEDs 23 and 24. It is possible to form the wiring patterns on the back of the substrate 19 opposite to the LED mounting surface. In that case, however, there is a risk of the wiring pattern being damaged by heat that is generated from the LEDs 23 and 24 while they are emitting. Besides, taking account of the requisite number of manufacturing processes on the substrate 19, it is preferable to form the wiring patterns on the LED mounting surface of the substrate 19 by etching or another conventional method.

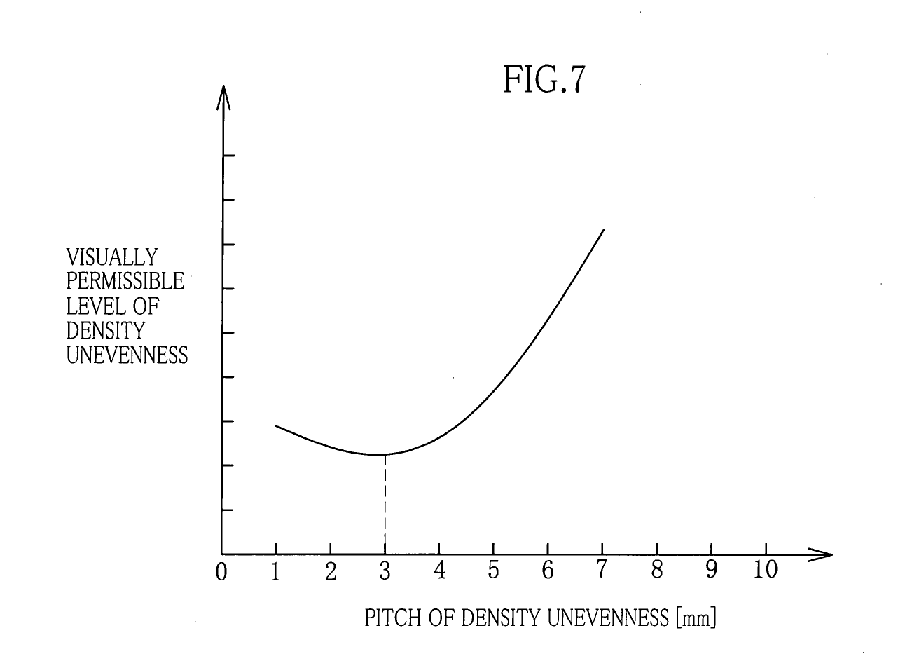

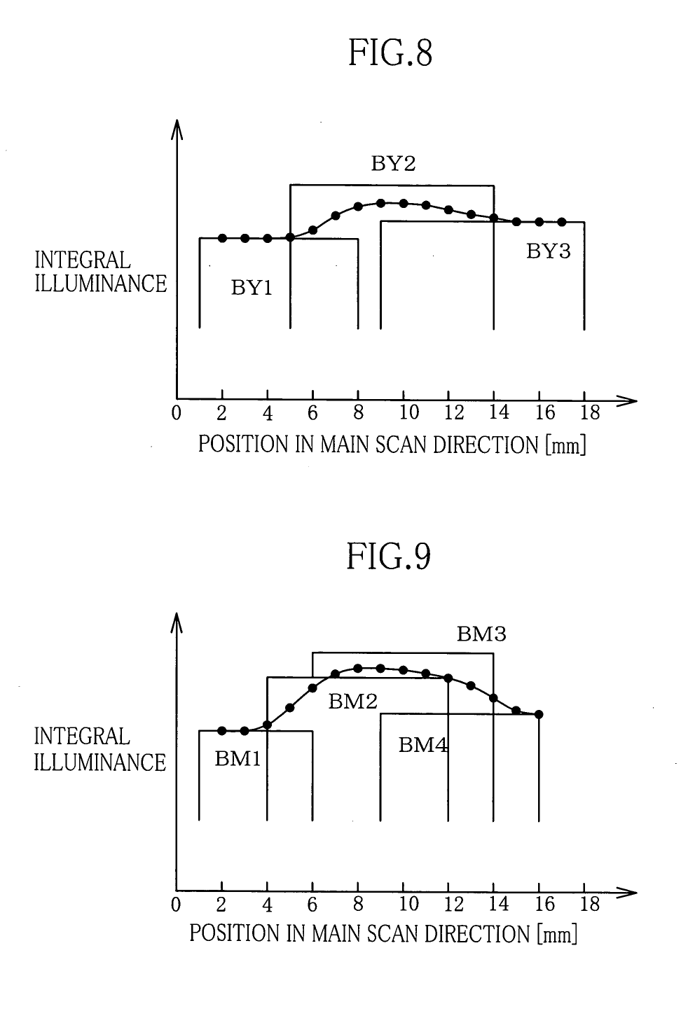

FIG. 7 shows a relationship between the pitch of density unevenness and visually permissible level of density unevenness that is an index of whether the density unevenness of the image is visible to the naked eyes, or not. The lower the visually permissible level of density unevenness, the more the density unevenness becomes apparent. The present inventor has experimentally found that the density unevenness is the most apparent and thus conspicuous when its pitch is around 3 mm, and that the visually permissible level of density unevenness gets higher and thus the density unevenness becomes less conspicuous by making interval of occurrence of the illuminance unevenness not less than 4 mm.

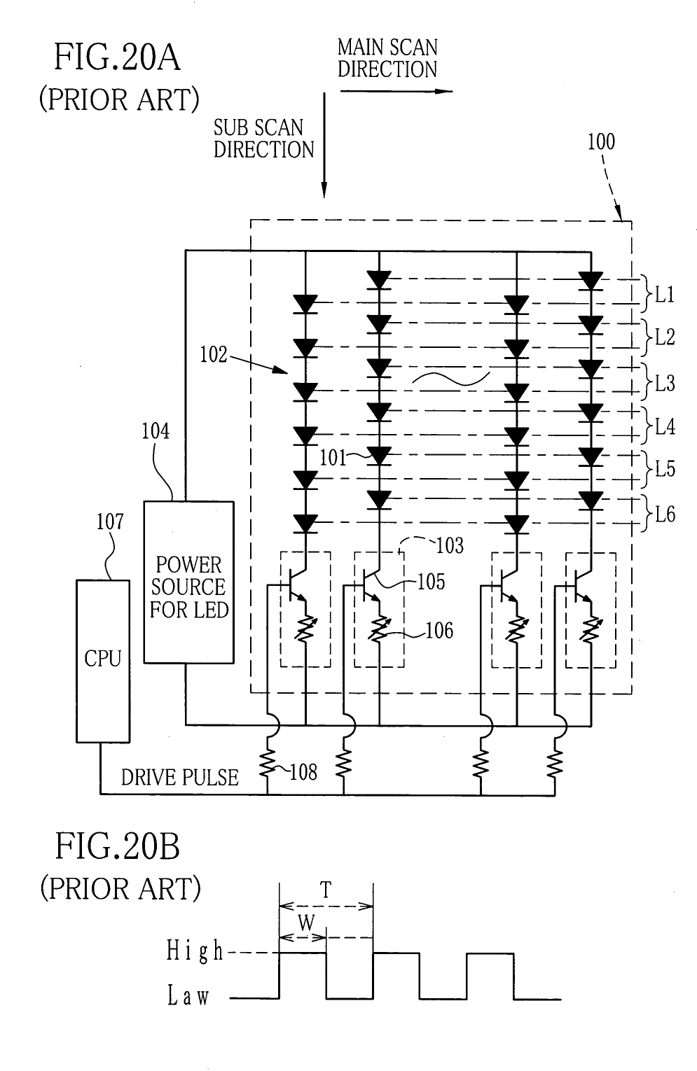

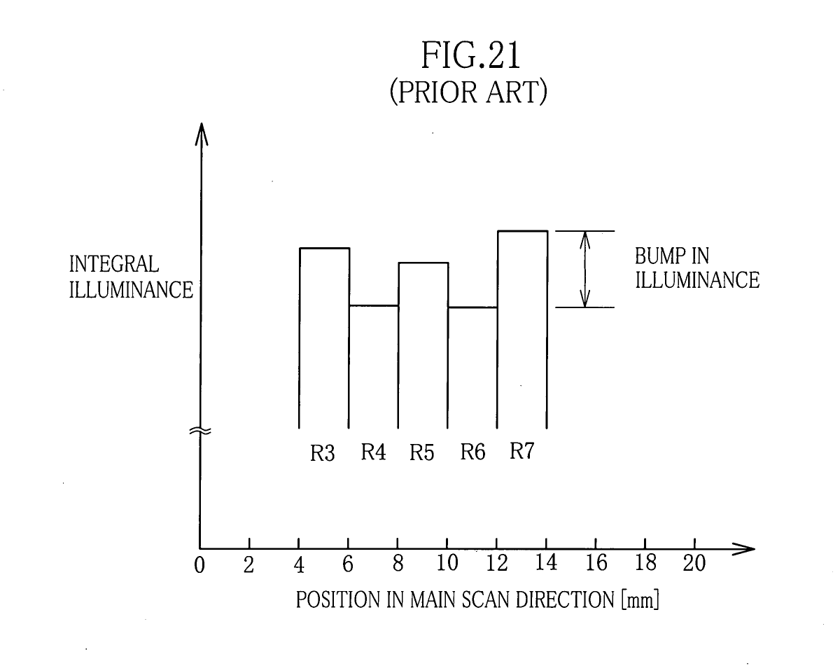

If the pitch P between the LEDs 101 is set at 4 mm in the main scan direction in the conventional wiring method as shown in FIG. 20A, and the current to each block 102 is not individually controlled, the integral illuminance varies at regular intervals of P/2=2 mm, on the assumption that the blocks 102 are staggered in the main scan direction. Accordingly, if the driver IC 25 has variations of −4% to +4% between the output terminals, bumps in the integral illuminance, which occur at the interval of 2 mm, can be 8% at the maximum in the conventional arrangement, as shown FIG. 21. Since there are characteristic variations between the LEDs, the bumps in the illuminance can be more than 8%. Because the interval of 2 mm is close to the interval of 3 mm at which the illuminance unevenness causes the most conspicuous density unevenness, the conventional arrangement is troublesome.

On the other hand, according to the arrangement of the yellow fixing light emitting element array 20 of FIG. 3, the LEDs 23 of the first block BY1 and ones of the second block BY2 partly overlap in the main scan direction, so that integral illuminance SY1 of the LEDs 23 of the first block BY1 and integral illuminance SY2 of the LEDs 23 of the second block BY2 affect each other in the main scan direction. So the integral illuminances SY1 and SY2 in the sub scan direction will be averaged in the main scan direction, e.g. SY1/2+SY2/2, and the integral illuminances vary gradually in the main scan direction from the position where the LEDs 23 of the first block BY1 do not overlap with the LEDs 23 of the second block BY2 to the position where the LEDs 23 of the first block BY1 overlap with the LEDs 23 of the second block BY2.

In the same reason as above, integral illuminance in the main scan direction varies gradually in the position where the LEDs 23 of the second block BY2 overlap with those of the third block BY3. It can be held that the integral illuminance varies from end to end of the second block BY2 with respect to the first to third blocks BY1 to BY3, and that the integral illuminance varies from end to end of the third block BY3 with respect to the second to fourth blocks BY2 to BY4. Therefore, the pitch of the illuminance unevenness is elongated to 9/2=4.5 mm. Besides, the integral illuminances of the respective blocks BY1 to BY3 affect each other, so that the rate of illuminance variation is reduced to 8/2=4% at the maximum. Consequently, connecting the LEDs of the respective blocks BY2 to BY33 in the manner shown in FIG. 3 will elongate the pitch of illuminance unevenness to a value where the density unevenness is inconspicuous, and also reduce the illuminance variation rate per one pitch. That is, the density unevenness is reduced without the need for controlling the current to each block individually, which contributes to simplifying the structure of the optical fixing device 15 as a surface luminous device, and thus reducing the size and saving the cost of the optical fixing device 15.

In the same way as for the yellow fixing light emitting element array 20, the illuminance unevenness of the magenta fixing light emitting element array 21 shown in FIG. 4 shows such characteristics as shown in FIG. 9. Since the LEDs 24 of the second to fourth blocks BM2 to BM4 overlap one subgroup with another in the main scan direction, respective integral illuminances SM2 to SM4 of these blocks BM2 to BM4 affect each other in the main scan direction. For example, the integral illuminances SM2 to SM4 are averaged such that they have a value SM2/2+SM3/2 or SM2/3+SM3/3+SM4/3. So the integral illuminances vary gradually from a position where the integral illuminance SM1 is added to the integral illuminance SM2 to a position where the integral illuminances SM2, SM3 and SM4 are added together, even if there is a large difference of 8% in current value between the second block BM2 and the third block BM3, or between the third block BM3 and the fourth block SM4. In the same way, integral illuminance SM5 of the fifth block BM5 and those of the following blocks vary gradually in the main scan direction. It can be held that the integral illuminance varies from end to end of the third block BM3 with respect to the second to fourth blocks BY2 to BY4, and that the integral illuminance varies from end to end of the fourth block BM4 with respect to the third to fifth blocks BM3 to BM5. Although the interval of the illuminance unevenness is 9/3=3 mm, where the density unevenness is the most conspicuous, since the integral illuminances of the respective blocks affect each other, the rate of illuminance variation is reduced to 8/3% at the maximum, that is less than 3%. Consequently, connecting the LEDs of the respective blocks in the manner shown in FIG. 4 will reduce the illuminance variation rate per one pitch, so that the density unevenness is reduced without the need for controlling the current to each block individually.

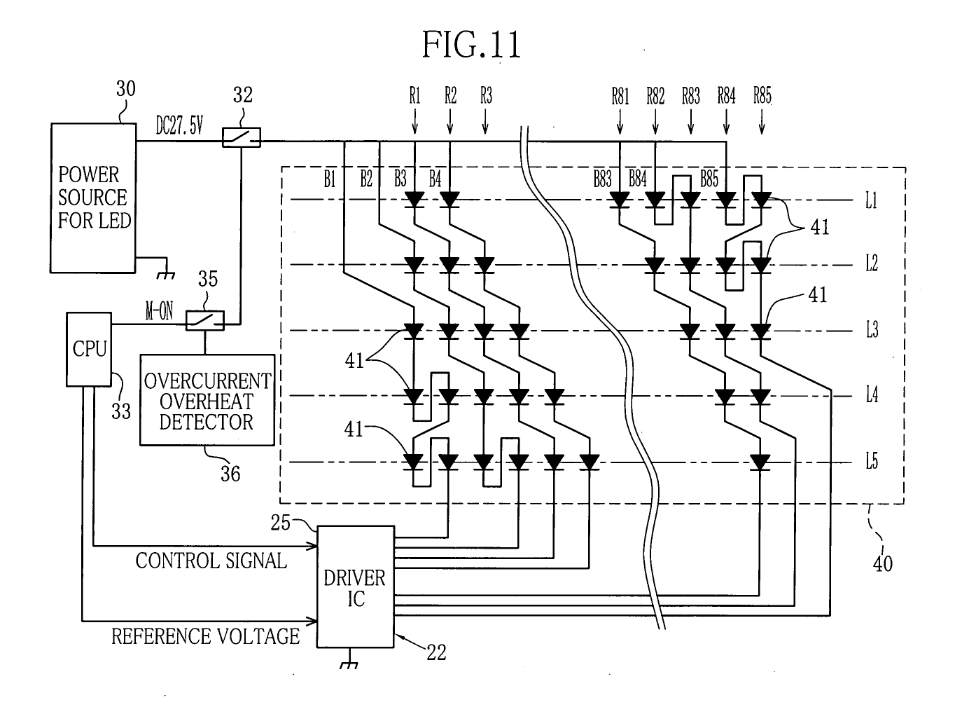

Next a light emitting element array 40 according to another embodiment will be described with reference to FIGS. 10 and 11. According to this embodiment, LEDs 41 are arranged in five lines L1, L2, L3, L4 and L5, and in eighty-five columns R1 to R85. Each line extends in the main scan direction, as shown in FIG. 10.

As shown in FIG. 11, every five of the LEDs 41 are connected in serial to each other to form a block, and a driver IC 25 drives the LEDs 41 of these blocks B1 to B85 separately from one block to another. In the second embodiment, same or like components are designated by the same reference numerals, so the description of these components will be omitted to avoid redundancy.

From the third block B3 to the eighty-third block B83, the five LEDs 41 of each block are arranged respectively on the five lines L1 to L5, such that they are located diagonally to each other in the main and sub scan directions.

According to the need for aligning the LEDs 41 on opposite ends along the sub scan direction, the LEDs 41 of the first and second blocks B1 and B2 on one end of the main scan direction as well as the LEDs 41 of the eighty-fourth and eighty-fifth blocks B84 and B85 on the other end are arranged differently from the regular arrangement of the LEDs 41 of the third to eighty-third blocks B3 to B83. Specifically, the first block B1 consists of one LED 41 located in the first column R1 of the third line L3, two LEDs 41 located in the first and second columns R1 and R2 of the fourth line L4, and two LEDs 41 located in the first and second columns R1 and R2 of the fifth line L5. The second block B2 consists of one LED 41 located in the first column R1 of the second line L2, one LED 41 located in the second column R2 of the third line L1, one LED 41 located in the third column R3 of the fourth line L4, and two LEDs 41 located in the third and fourth column R3 and R4 of the fifth line L5. The eighty-fourth block B84 consists of two LEDs 41 located in the eighty-second and eighty-third columns R82 and R83 of the first line L1, one LED 41 located in the eighty-third column R83 of the second line L2, one LED 41 located in the eighty-fourth column R84 of the third line L3, and one LED 41 located in the eighty-fifth column R85 of the fourth line L4. The eighty-fifth block B85 consists of two LEDs 41 located in the eighty-fourth and eighty-fifth columns R84 and R85 of the first line L1, two LEDs 41 located in the eighty-fourth and eighty-fifth columns R84 and R85 of the second line L2, and one LED 41 located in the eighty-fifth column R85 of the third line L3.

According to the embodiment shown in FIGS. 10 and 11, the number “q” of LEDs serially connected to each other to form one block is five, and the number “m” of lines of the LEDs is five, so that q=m. By staggering the LEDs 41 so as not to overlap each other in the main scan direction in almost all blocks except the terminal blocks B1, B2, B84 and B85, illuminance unevenness across the main scan direction is made unconscious in the center portion of the image recording area, where the illuminance unevenness would have more influence on the image quality.

To say in more detail, because the LEDs 41 of the blocks B3 to B7 partly overlap one another in the main scan direction, integral illuminances in the main scan direction are integrated values of the light emission from the LEDs 41 of the third to seventh blocks B3 to B7 or those of the fourth to eight blocks B4 to 18. For example, the integral illuminance is an average value of integral illuminances S3 to S7 of the third to seventh blocks B3 to B7, i.e. (S3+S4+S5+S6+S7)/5, or an average value of integral illuminances S4 to S8 of the fourth to eighth blocks B4 to B8, i.e. (S4+S5+S6+S7+S8)/5. Therefore, the integral illuminances vary gradually from the third block B3, even if there is a large difference of 8% in integral current value between the third block B3 and the fourth block B4, or between the fourth block B4 and the fifth block S5.

It can be considered that, from the third block B3, the integral illuminance varies at the same intervals as the pitch of arrangement of the light emitting elements in the main scan direction. Although the integral illuminance varies at the interval of 4 mm in the present embodiment, that is close to 3 mm where the density unevenness is the most conspicuous, since the integral illuminances of the respective blocks affect each other, the rate of illuminance variation is reduced to 8/5% at the maximum that is less than 2%. Consequently, connecting the LEDs of the respective blocks in the manner shown in FIG. 11 will reduce the illuminance variation rate per one pitch, so that the density unevenness is reduced without the need for controlling the current to each block individually, which contributes to simplifying the structure of the surface luminance device, and thus reducing the size and the cost thereof.

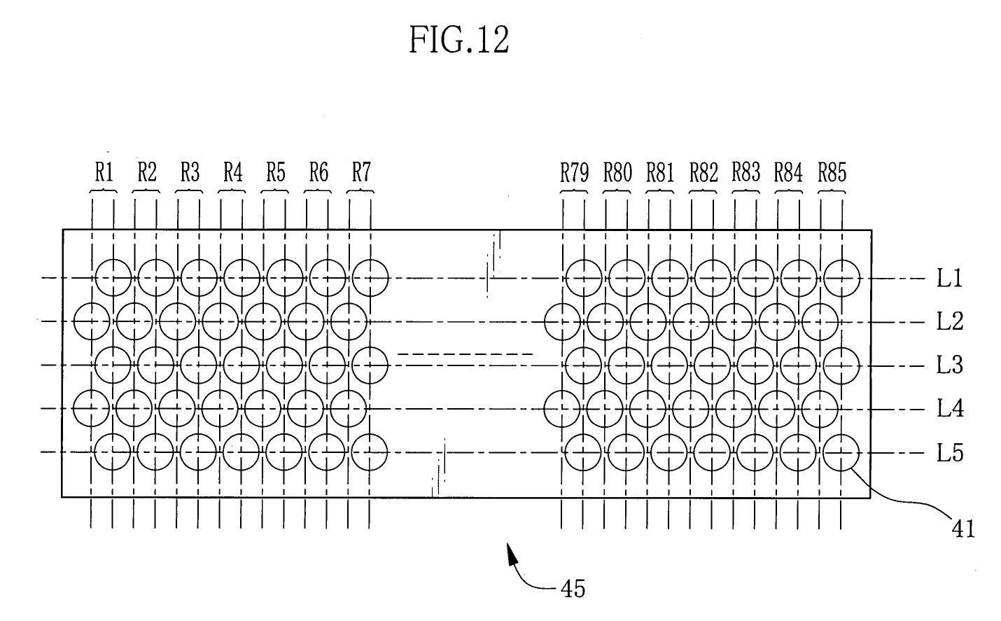

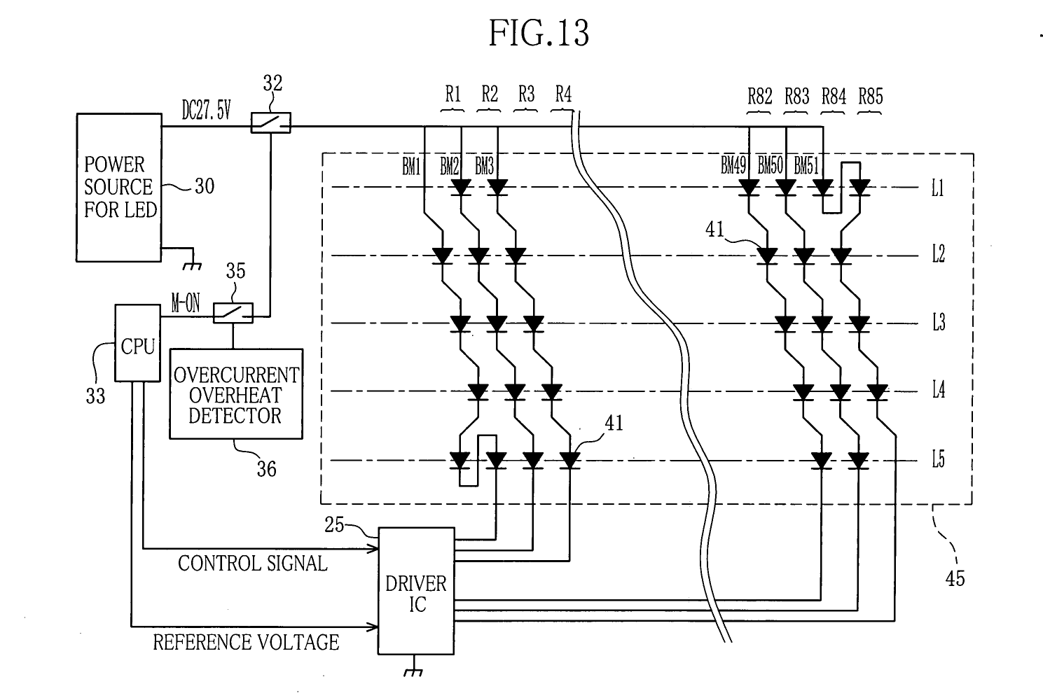

FIGS. 12 and 13 show a variation from the second embodiment shown in FIGS. 10 and 11. In a light emitting element array 45 of this variation, LEDs 41 of even lines L2 and L4 are staggered by a half pitch from LEDs 41 of odd lines L1, L3 and L5. The light emitting element array 45 is configured in the same way as the light emitting element array 40, except that LEDs constituting blocks D1, D2, D84 and D85 on opposite ends in the main scan direction are arranged differently from those in the light emitting element array 40. Staggering the LEDs 41 in this way reduces unevenness in the main scan direction of light amount cumulated in the sub scan direction.

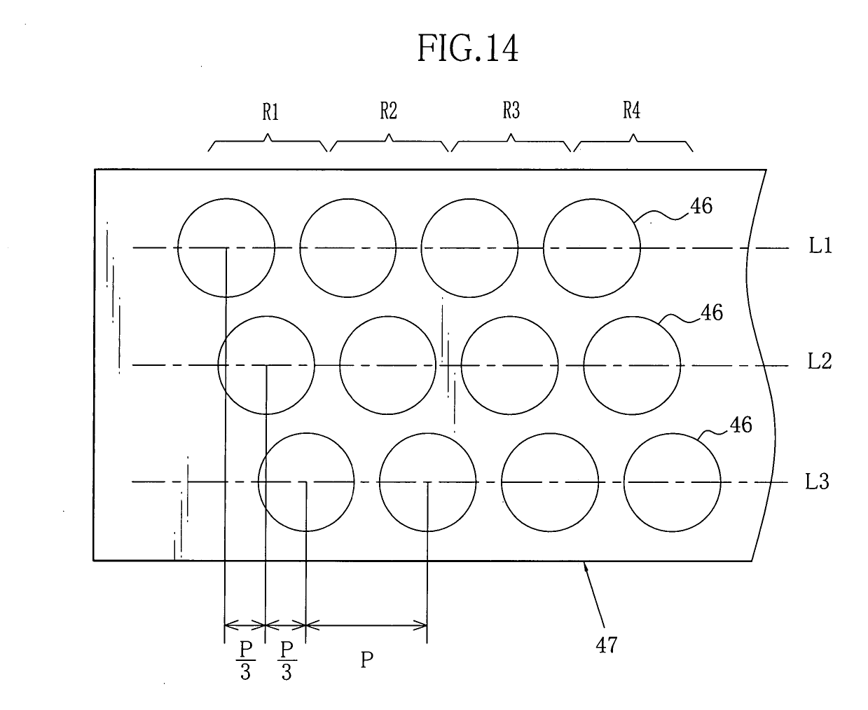

In this way, as shown in FIGS. 2 and 12, the light emitting elements of the even lines may be staggered from the light emitting elements of the odd lines by a half pitch P/2 in the main scan direction, wherein P represents a pitch or interval between the light emitting elements in the main scan direction, or they may be aligned in the main and sub scan directions, as shown in FIG. 10. Furthermore, as shown in FIG. 14, LEDs 46 of first to third lines L1 to L3 of a light emitting element array 47 may be staggered from those of the adjacent lines in the main scan direction by one third of a pitch P between the LEDs 46 in the main scan direction. In the embodiment of FIG. 14, all the LEDs including those on opposite ends of the respective lines do not overlap in the sub scan direction. However, the smaller the respective LEDs are staggered in the main scan direction from those of the adjacent lines, the degree of distribution in the main scan direction of the LEDs of the same block decreases, so that the suppressive effect on the illuminance unevenness decreases. Therefore, it is preferable to decide an appropriate amount of staggering between the LEDs in accordance with the number and conditions of arrangement of the LEDs, purpose and required accuracy of the luminous device, and other factors.

Increasing the number “q” of LEDs that are connected in serial to each other as one block will raise the distribution degree in the main scan direction of the LEDs within the same block, thereby making the illuminance unevenness between the blocks inconspicuous. On the contrary, however, the larger the number “q”, the higher the necessary power becomes. Besides, the larger the number “m” of lines of the light emitting elements, the greater the scale of the luminous device. Accordingly, it is preferable to decide the number “q” of LEDs in a block and the number “m” of lines of the LEDs appropriately in accordance with purpose and required accuracy of the luminous device, and other factors. Although the number “n” of LEDs arranged in a line is constant in the illustrated embodiment, it is possible to change the number “n” between the lines.

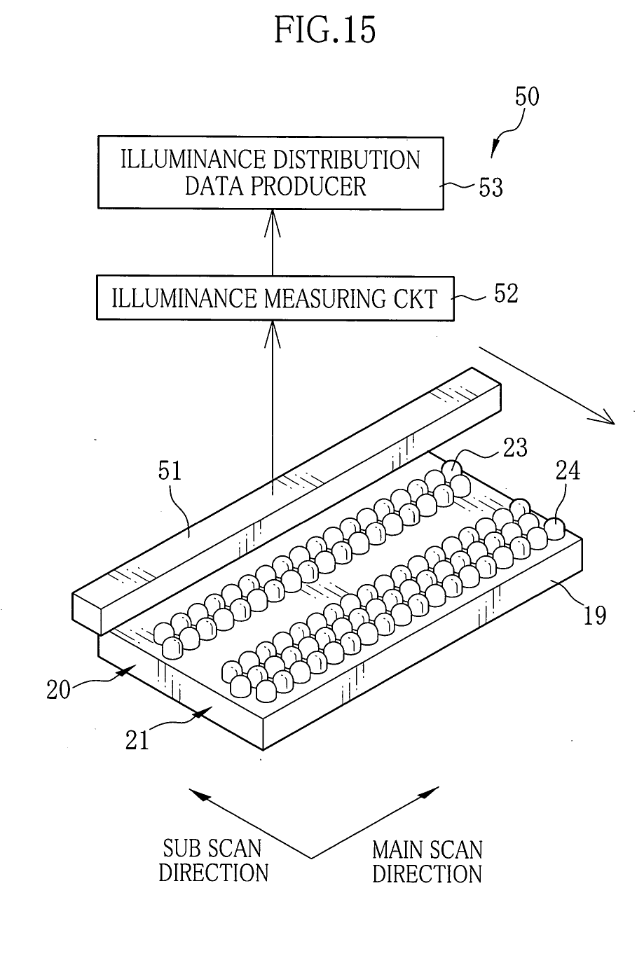

FIG. 15 shows a measuring device 50 for measuring illuminance of the yellow and magenta fixing light emitting element arrays 20 and 21. The measuring device 50 consists of a photoreceptive sensor 51, an illuminance measuring circuit 52 and an illuminance distribution data producer 53. The photoreceptive sensor 51 consists of a large number of photo transistors arranged in the main scan direction. The photoreceptive sensor 51 is movable in the sub scan direction, to receive light from the LEDs 23 and 24 while moving in the sub scan direction, and sends the illuminance measuring circuit 52 the an electric signal that represents the received light amount.

The illuminance measuring circuit 52 converts the electric signal from the photoreceptive sensor 51 into a digital signal, and sends it to the illuminance distribution data producer 53. The illuminance distribution data producer 53 integrates the illuminance of the LEDs 23 column by column of the yellow fixing light emitting element array 20, to produce integral illuminances of individual columns, which are served as illuminance distribution data. As for the magenta fixing light emitting element array 21, illuminance distribution data is obtained in the same way as for the yellow fixing light emitting element array 20.

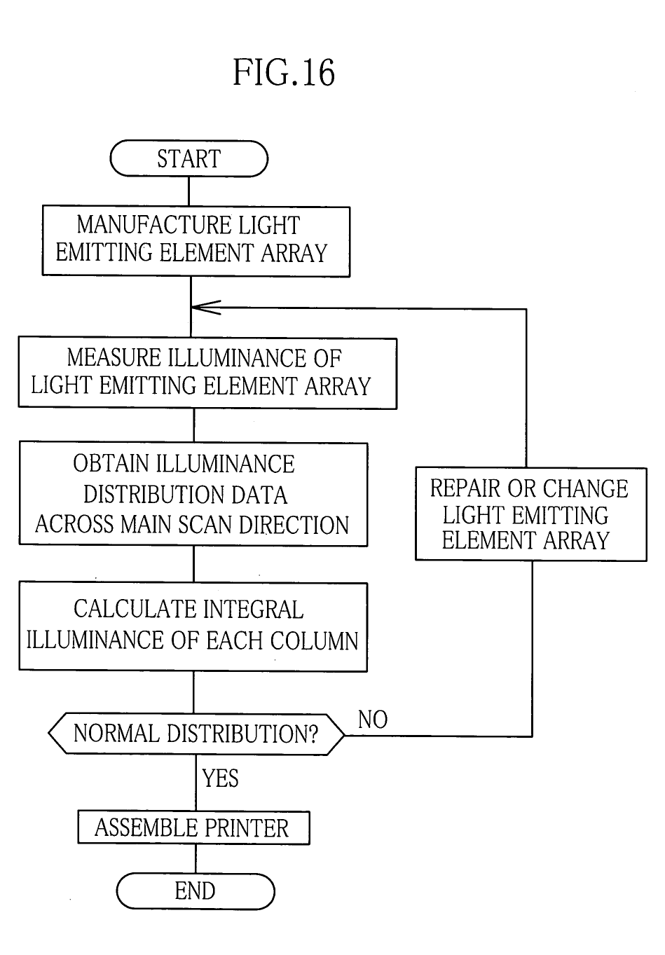

As shown in FIG. 16, after being manufactured, the light emitting element arrays are subjected to an inspection process, where the illuminance measuring device 50 obtains data of illuminance distribution across the main scan direction of each light emitting element array. Thereafter, if the illuminance distribution across the main scan direction is judged to be within a standard range, the light emitting element array is sent to a printer assembling process. If the illuminance distribution is judged to be out of the standard range, the light emitting element array is repaired or replaced with another, and is subjected to the inspection process again.

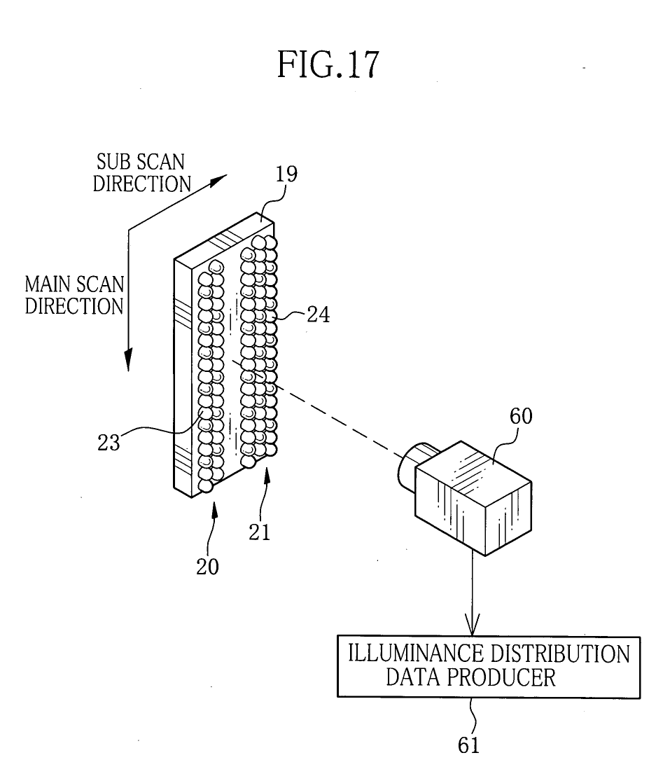

To obtain data of illuminance distribution across the main scan direction of each light emitting element array, it is possible to use an imaging device like a CCD camera 60, as shown in FIG. 17, in place of the illuminance measuring device 50. The CCD camera 60 sends data of light amount from the individual light emitting element array 20 or 21 to an illuminance distribution data producer 61, which calculates integral illuminance of each column of the array on the basis of the data from the CCD camera 60.

As another method of obtaining illuminance distribution data across the main scan direction, it is possible to project the fixing light onto a test recording paper to check unevenness of fixation in practice. In that case, the yellow fixing light emitting element array 20 is first activated to project the yellow fixing light on to the test recording paper as it is conveyed through the yellow fixing light emitting element array 20. Thereafter, a constant amount of heat energy is applied from a thermal head onto the test recording paper, to record an yellow image at a uniform density. The thermal head is adjudged in advance so that the heating energy does not have any unevenness.

If there are incompletely fixed areas on the test recording paper, these areas will be colored yellow. From the yellow coloring density of the test recording paper, integral illuminances of the respective lines of the yellow fixing light emitting element array 20 are derived, to obtain data of illuminance distribution across the main scan direction. As for the magenta fixing light emitting element array 21, data of illuminance distribution across the main scan direction is obtained in the same way. In order to let the uneven fixation be reflected apparently in the coloring density of the test recording paper, the volume of the fixing light used for the test should preferably be lower than that used for the actual optical fixation.

Although the present invention has been described with respect to the optical fixing device 15 that uses the yellow and magenta fixing light emitting element arrays 20 and 21, or the light emitting element array 40, 45 or 47, the present invention is not to be limited to these embodiments, but may be applicable as an optical fixing device for fixing an ink-jet image recorded with ink that contains an ultraviolet-cured resin or the like, or a surface treatment device for laminated paper.

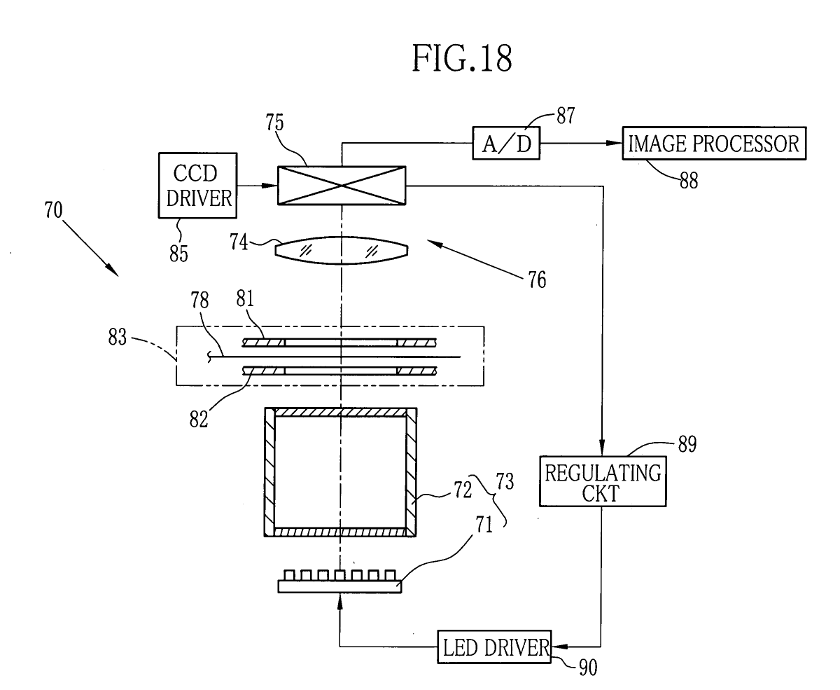

Furthermore, as shown in FIG. 18, the present invention is applicable to a luminous device 71 of an image reading apparatus 70 that reads images from photographic film. The image reading device 70 has a light source section 73 and an imaging section 76. The light source section 73 consists of the luminous device 71 and a light diffusion box 72, whereas the imaging section 76 consists of a lens unit 74 and an planer CCD 75. A film carrier 83 including a pair of masks 81 and 82 for setting the photographic film 78 is placed above the light diffusion box 72. The luminous device 71 projects reading light beams of red, green, blue and infrared from LEDs. The planer CCD 75 is controlled by a CCD driver 85, to read the image of the photographic film 78 color by color. The image data read out through the planer CCD 75 is output to an image processor 88 through an A/D converter 87. Besides, the reading result of the planer CCD 75 is sent to a regulating circuit 89 to control the light volume from the luminous device 71 by an LED driver 90.

Using the luminous device of the present invention contributes to making unevenness in light volume between individual blocks of LEDs inconspicuous as the LEDs are driven block by block. Since the light diffusion box diffuses the light from the LEDs, the light projected onto the photographic film is still more homogenized.

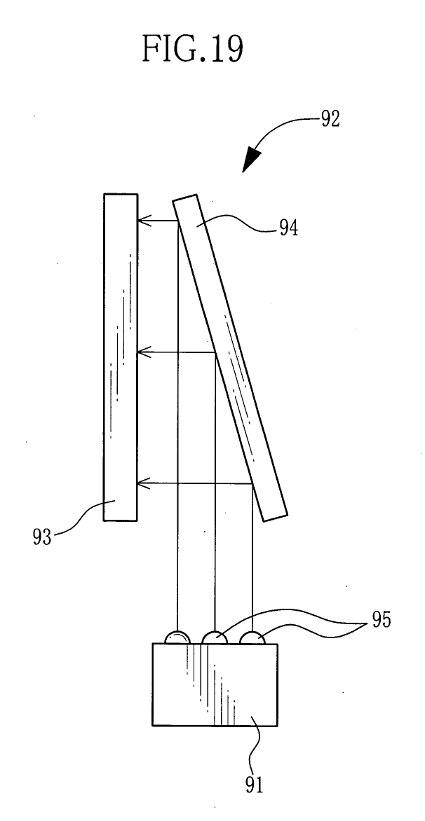

The present invention is also applicable to a luminous device 91 for such a flat panel display 92 as shown in FIG. 19. The flat panel display 92 is constituted of a display panel 93 consisting of a color liquid crystal panel or the like, the luminous device 91 that projects light from LEDs 95 for illuminating the display panel 93, and a mirror 94 for reflecting the light from the luminous device 91 toward the back of the display panel 93. Also in this case, unevenness in light volume between individual blocks of LEDs 95 is made inconspicuous as the LEDs 95 are driven block by block.

Although the above described embodiments use LEDs as light emitting elements, any kinds of point light sources are usable instead of the LED, to get the same effects as above.

Thus, the present invention is not to be limited by the above described embodiments, but various modifications will be possible without departing from the scope of claims appended hereto.

What is claimed is:

1. A luminous device comprising an array of light emitting elements wherein said light emitting elements are aligned in a plural number “m” of lines which extend in a first direction, and are apposed in a second direction orthogonal to said first direction, and said array is grouped into a number of blocks to be driven block by block, each of said blocks consisting of a number “q” of said light emitting elements connected in serial to one another, the number “q” being equal to or larger than the number “m”, and wherein said light emitting elements of each block are divided into the number “m” of subgroups consisting of one or more than one of said light emitting elements each, such that one subgroup is allocated to one line in each block, to arrange said light emitting elements of different blocks substantially in the same columns in said second direction.

2. A luminous device as claimed in claim 1, wherein said light emitting elements of one line are staggered by P/2 from ones of adjacent lines in said first direction, assuming that said light emitting elements are arranged at an interval of P in each line.

3. A luminous device as claimed in claim 1, wherein said light emitting elements of one line are staggered by P/m from ones of adjacent lines, assuming that said light emitting elements are arranged at an interval of P in each line.

4. An optical fixing device for a direct color thermal printer that records images on a heat sensitive color recording paper by heating it with a thermal head having an array of heating elements arranged in a main scan direction while conveying said heat sensitive color recording paper in a sub scan direction orthogonal to said main scan direction, said heat sensitive recording paper having at least first to third heat sensitive coloring layers for developing different colors, wherein said optical fixing device comprises first and second light emitting element arrays for projecting a first fixing light of a specific wavelength range and a second fixing light of another specific wavelength range to fix said first and second heat sensitive coloring layers respectively, each of said first and second light emitting element arrays consisting of light emitting elements which are aligned in a plural number “m” of lines which extend in said main scan direction, and are apposed in said sub scan direction, and said array being grouped into a number of blocks to be driven block by block, each of said blocks consisting of a number “q” of said light emitting elements connected in serial to one another, the number “q” being equal to or larger than the number “m”, and wherein said light emitting elements of each block are divided into the number “m” of subgroups consisting of one or more than one of said light emitting elements each, such that one subgroup is allocated to one line in each block, to arrange said light emitting elements of different blocks substantially in the same columns in said second direction.

5. A luminous device as claimed in claim 4, wherein said light emitting elements of one line are staggered by P/2 from ones of adjacent lines in said main scan direction, assuming that said light emitting elements are arranged at an interval of P in each line.

6. A luminous device as claimed in claim 4, wherein said light emitting elements of one line are staggered by P/m from ones of adjacent lines in said main scan direction, assuming that said light emitting elements are arranged at an interval of P in each line.
